(19) United States
(12) Patent Application Publication
(10) Pub. No.: US 2008/0286522 A1
(43) Pub. Date: Nov. 20, 2008

(54) Honeycomb having a low coefficient of thermal expansion and articles made from same

(76) Inventors: Subhotosh Khan, Midlothian, VA (US); Mikhail R. Levit, Glen Allen, VA (US); Gary Lee Hendren, Richmond, VA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/639,467

(22) Filed: Dec. 15, 2006

(51) Int. Cl. B32B 3/12

(52) U.S. Cl. 428/116

(57) ABSTRACT

This invention relates to a honeycomb and articles made therefrom, the articles having cell walls provided with a structural or matrix resin, the planes of the cell walls being parallel to the Z-dimension of the honeycomb, the honeycomb cell walls comprising 5 to 35 parts by weight thermoplastic material having a melting point of from 120° C. to 350° C. and a coefficient of thermal expansion of 180 ppm/° C. or less; and 65 to 95 parts by weight of a high modulus fiber having a modulus of 525 grams per denier (480 grams per dtex) or greater and having an axial coefficient of thermal expansion of 2 ppm/° C. or less, based on the total amount of thermoplastic and high modulus fiber in the honeycomb cell walls; wherein the honeycomb has a coefficient of thermal expansion in the Z-dimension of 10 ppm/° C. or less as measured by ASTM E831.

### BACKGROUND OF THE INVENTION

1. Field of the Invention

This invention relates to a high performance honeycomb whose thickness is substantially insensitive to temperature changes.

2. Description of Related Art

High modulus honeycomb is used in various applications where dimensional stability with temperature changes is important, such as in aircraft. Traditionally such honeycomb has been manufactured from paper made with high modulus para-aramid fiber and meta-aramid fibrid binders. Because of the nature of these aramid materials, honeycombs made from them are very dimensionally stable. Potentially, papers made with thermoplastic binders, when made into honeycomb, could provide easier shaping of the honeycomb during its processing into the final sandwich panel of desired configuration. However, honeycombs made with thermoplastic binders can suffer from excessive dimensional changes with temperature changes. Therefore what is needed is a paper composition using a thermoplastic binder, that when made into honeycomb results in a honeycomb that is substantially dimensionally insensitive to temperature over a wide temperature range.

### BRIEF SUMMARY OF THE INVENTION

This invention relates to a honeycomb having cell walls provided with a structural or matrix resin, the planes of the cell walls being parallel to the Z-dimension of the honeycomb, the honeycomb cell walls comprising 5 to 35 parts by weight thermoplastic material having a melting point of from 120° C. to 350° C. and a coefficient of thermal expansion of less than 180 ppm/° C.; and 65 to 95 parts by weight of a high modulus fiber having a modulus of 525 grams per denier (480 grams per dtex) or greater and having an axial coefficient of thermal expansion of 2 ppm/° C. or less, based on the total amount of thermoplastic and high modulus fiber in the honeycomb cell walls; wherein the honeycomb has a coefficient of thermal expansion in the Z-dimension of 10 ppm/° C. or less as measured by ASTM E831. This invention also relates to articles made from the honeycomb, including panels and aerodynamic structures.

### BRIEF DESCRIPTION OF THE DRAWINGS

FIGS. 1a and 1b are representations of views of a hexagonal shaped honeycomb.

FIG. 2 is a representation of another view of a hexagonal cell shaped honeycomb.

FIG. 3 is an illustration of honeycomb provided with facesheet(s).

### DETAILED DESCRIPTION OF THE INVENTION

This invention relates to a honeycomb made from a paper comprising high modulus fiber and thermoplastic material whose thickness, or “Z” dimension, is substantially insensitive to temperature changes.

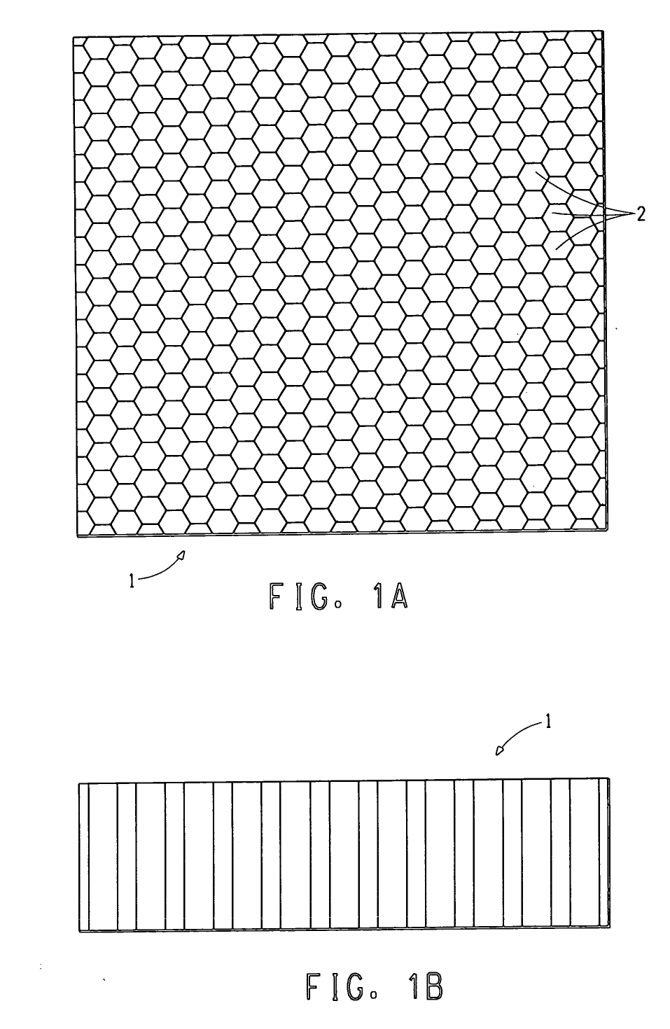

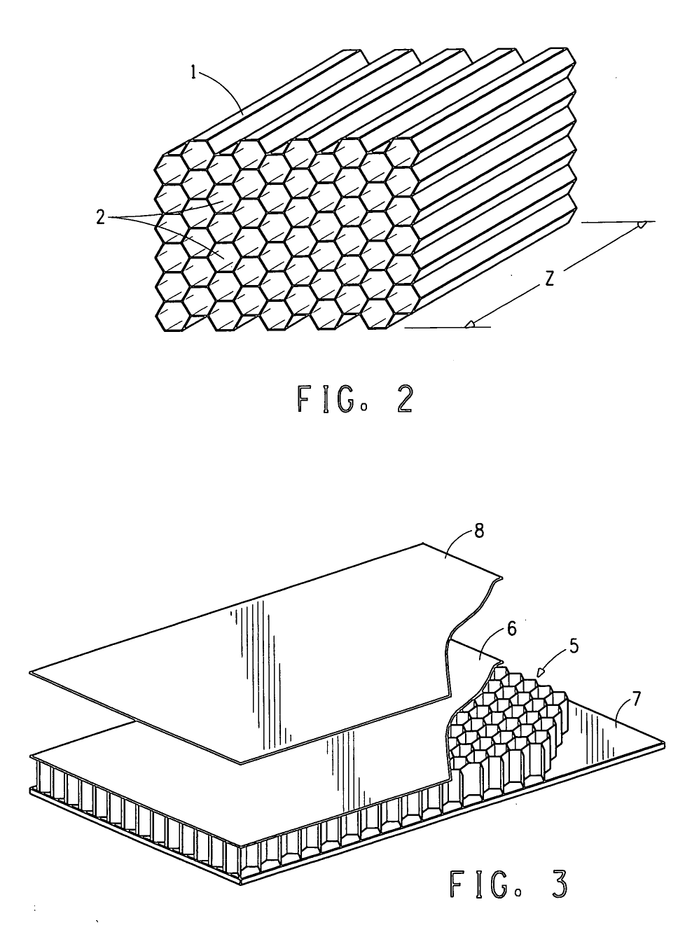

FIG. 1a is one illustration of one honeycomb of this invention. FIG. 1b is an orthogonal view of the honeycomb shown in FIG. 1a and FIG. 2 is a three-dimensional view of the honeycomb. Shown is honeycomb 1 having hexagonal cells 2. The “Z” dimension or the thickness of the honeycomb is shown in FIG. 2. Hexagonal cells are shown; however, other geometric arrangements are possible with square and flex-core cells being the other most common possible arrangements. Such cell types are well known in the art and reference can be made to Honeycomb Technology by T. Bitzer (Chapman & Hall, publishers, 1997) for additional information on possible geometric cell types.

The honeycomb is provided with a structural or matrix resin, typically a thermoset resin that fully impregnates, saturates, or coats the cell walls of the honeycomb. The resin is then further crosslinked or cured to realize of the final properties (stiffness and strength) to the honeycomb. In some embodiments these structural resins include epoxy resins, phenolic resins, acrylic resins, polyimide resins, and mixtures thereof.

The honeycomb of this invention has a coefficient of thermal expansion (CTE) in the Z-dimension of 10 ppm/° C. or less as measured by ASTM E831, preferably 5 ppm/° C. or less. Such dimensional stability is critical for such applications as outer space applications where the material (if rotating) will cycle between two extremes in temperature creating significant weakening of the structure as it expands and contracts. Other applications include the leading edges of wing structures where the honeycomb is exposed to extreme temperature changes between take-off/landing and flight (above about 8000 meters). It is desired that such materials have no dimensional change with temperature, or that the CTE be as close to zero as possible. Therefore used herein, a positive CTE limitation means the dimension of the material does not increase or expand more than that amount; a negative CTE limitation means the dimension does not decrease or contract more than that amount.

The CTE of honeycomb can be measured directly on the honeycomb using a TA Instruments thermomechanical analyzer. Preferred specimen size is 6 mm×6 mm×25 mm (direction of measurement) for a honeycomb of 3 mm cell size. These measurements can also be made on stabilized honeycombs (i.e. honeycombs provided with one or more facesheets) where the properties of the facesheets are subtracted out from the composite properties.

The cell walls of the honeycomb are preferably formed from a paper comprising a high modulus fiber and a thermoplastic material. In some embodiments the term paper is employed in its normal meaning and refers to a nonwoven sheet prepared using conventional wet-lay papermaking processes and equipment. However, the definition of paper in some embodiments includes, in general, any nonwoven sheet that requires a binder material and has properties sufficient to provide an adequate honeycomb structure.

The thickness of the paper used in this invention is dependent upon the end use or desired properties of the honeycomb and in some embodiments is typically from 1 to 5 mils (25 to 130 micrometers) thick. In some embodiments, the basis weight of the paper is from 0.5 to 6 ounces per square yard (15 to 200 grams per square meter).

The paper used in the honeycomb of this invention comprises 5 to 35 parts by weight thermoplastic material having a melting point of from 120° C. to 350° C. and a coefficient of thermal expansion of less than 180 ppm/° C., and 65 to 95 parts by weight of a high modulus fiber having a modulus of 525 gpd (480 grams per dtex) or greater and an axial CTE of 2 ppm/° C. or less, based on the total amount of thermoplastic material and high modulus fiber in the paper. In some preferred embodiments the thermoplastic has a CTE of less than 100 ppm/° C., and in some preferred embodiments the high modulus fiber has an axial CTE of (−1) ppm/° C. or less. In some embodiments the high modulus fiber is present in the paper in an amount of from about 80 to 95 parts by weight, and in some embodiments the thermoplastic material is present in the paper in an amount of from 5 to 20 parts by weight. In some embodiments at least 50 wt. % of the high modulus fiber in the paper composition is in the form of floc.

The paper can also include inorganic particles and representative particles include mica, vermiculite, and the like; the addition of these particles can impart properties such as improved fire resistance, thermal conductivity, dimensional stability, and the like to the paper and the final honeycomb.

The paper used in this invention can be formed on equipment of any scale, from laboratory screens to commercial-sized papermaking machinery, including such commonly used machines as Fourdrinier or inclined wire paper machines. A typical process involves making a dispersion of high modulus fibrous material such as floc and/or pulp and a binder material in an aqueous liquid, draining the liquid from the dispersion to yield a wet composition and drying the wet paper composition. The dispersion can be made either by dispersing the fibers and then adding the binder material or by dispersing the binder material and then adding the fibers. The final dispersion can also be made by combining a dispersion of fibers with a dispersion of the binder material; the dispersion can optionally include other additives such as inorganic materials. If the binder material is a fiber, the fiber can be added to the dispersion by first making a mixture with high modulus fibers, or the fiber can be added separately to the dispersion. The concentration of fibers in the dispersion can range from 0.01 to 1.0 weight percent based on the total weight of the dispersion. The concentration of a binder material in the dispersion can be up to 35 weight percent based on the total weight of solids. In a typical process, the aqueous liquid of the dispersion is generally water, but may include various other materials such as pH-adjusting materials, forming aids, surfactants, defoamers and the like. The aqueous liquid is usually drained from the dispersion by conducting the dispersion onto a screen or other perforated support, retaining the dispersed solids and then passing the liquid to yield a wet paper composition. The wet composition, once formed on the support, is usually further dewatered by vacuum or other pressure forces and further dried by evaporating the remaining liquid.

In one preferred embodiment high modulus fibrous material and a thermoplastic binder, such as a mixture of short fibers or short fibers and binder particles, can be slurried together to form a mix that is converted to paper on a wire screen or belt. Reference is made to U.S. Pat. No. 3,756,908 to Gross; U.S. Pat. Nos. 4,698,267 and 4,729,921 to Tokarsky; U.S. Pat. No. 5,026,456 to Hesler et al.; U.S. Pat. No. 5,223,094 to Kirayoglu et al.; U.S. Pat. No. 5,314,742 to Kirayoglu et al.; U.S. Pat. Nos. 6,458,244 and 6,551,456 to Wang et al.; and U.S. Pat. No. 6,929,848 and 2003-0082974 to Samuels et al. for illustrative processes for forming papers from various types of fibrous material and binders.

Once the paper is formed, it is preferably hot calendered. This can increase the density and strength of the paper. Generally one or more layers of the paper are calendered in the nip between metal-metal, metal-composite, or composite-composite rolls. Alternatively, one or more layers of the paper can be compressed in a platen press at a pressure, temperature, and time that are optimal for a particular composition and final application. Calendering paper in this manner also decreases the porosity of the formed paper, and in some preferred embodiments the paper used in the honeycomb is calendered paper. Heat-treatment of the paper, such as from radiant heaters or un-nipped rolls, as an independent step before, after, or instead of calendering or compression, can be conducted if strengthening or some other property modification is desired without, or in addition to, densification.

The honeycomb comprises high modulus fibers; as used herein high modulus fibers are those having a tensile or Young's modulus of 525 grams per denier (480 grams per dtex) or greater. High modulus of the fiber provides necessary stiffness of the final honeycomb structure and corresponding panel. In a preferred embodiment, the Young's modulus of the fiber is 900 grams per denier (820 grams per dtex) or greater. In the preferred embodiment, the fiber tenacity is at least 21 grams per denier (19 grams per dtex) and its elongation is at least 2% so as to provide a high level of mechanical properties to the final honeycomb structure. The axial CTE of the high modulus fiber is 2 ppm/C or less and in a preferred embodiment is (−1) ppm/C or less.

In a preferred embodiment the high modulus fiber is heat resistant fiber. By “heat resistant fiber” it is meant that the fiber preferably retains 90 percent of its fiber weight when heated in air to 500° C. at a rate of 20 degrees Celsius per minute. Such fiber is normally flame resistant, meaning the fiber or a fabric made from the fiber has a Limiting Oxygen Index (LOI) such that the fiber or fabric will not support a flame in air, the preferred LOI range being about 26 and higher.

The high modulus fibers can be in the form of a floc or a pulp or a mixture thereof, however in many embodiments floc is the preferred fiber form. By “floc” is meant fibers having a length of 2 to 25 millimeters, preferably 3 to 7 millimeters and a diameter of 3 to 20 micrometers, preferably 5 to 14 micrometers. Floc is generally made by cutting continuous spun filaments into specific-length pieces. If the floc length is less than 2 millimeters, it is generally too short to provide a paper with adequate strength; if the floc length is more than 25 millimeters, it is very difficult to form uniform wet-laid webs. Floc having a diameter of less than 5 micrometers, and especially less than 3 micrometers, is difficult to produce with adequate cross sectional uniformity and reproducibility; if the floc diameter is more than 20 micrometers, it is very difficult to form uniform papers of light to medium basis weights.

The term “pulp”, as used herein, means particles of high modulus material having a stalk and fibrils extending generally therefrom, wherein the stalk is generally columnar and about 10 to 50 micrometers in diameter and the fibrils are fine, hair-like members generally attached to the stalk measuring only a fraction of a micrometer or a few micrometers in diameter and about 10 to 100 micrometers long.

In some embodiments, the high modulus fibers useful in this invention include fiber made from para-aramid, polybenzazole, polypyridazole polymer, liquid crystal polyesters, carbon or mixtures thereof. In one preferred embodiment, the high modulus fiber is made from aramid polymer, especially para-aramid polymer. In an especially preferred embodiment the high modulus fiber is poly(paraphenylene terephthalamide).

As employed herein the term aramid means a polyamide wherein at least 85% of the amide (—CONH—) linkages are attached directly to two aromatic rings. “Para-aramid” means the two rings or radicals are para oriented with respect to each other along the molecular chain. Additives can be used with the aramid. In fact, it has been found that up to as much as 10 percent, by weight, of other polymeric material can be blended with the aramid or that copolymers can be used having as much as 10 percent of other diamine substituted for the diamine of the aramid or as much as 10 percent of other diacid chloride substituted for the diacid chloride of the aramid. In some embodiments the preferred para-aramid is poly(paraphenylene terephthalamide). Methods for making para-aramid fibers useful in this invention are generally disclosed in, for example, U.S. Pat. Nos. 3,869,430; 3,869,429; and 3,767,756. Such aromatic polyamide fibers and various forms of these fibers are available from E. I. du Pont de Nemours and Company, Wilmington, Del. under the trademark Kevlar® fibers and from Teijin, Ltd., under the trademark Twaron®.

Commercially available polybenzazole fibers useful in this invention include Zylon® PBO-AS (Poly(p-phenylene-2,6-benzobisoxazole) fiber, Zylon® PBO-HM (Poly(p-phenylene-2,6-benzobisoxazole)) fiber, available from Toyobo, Japan. Commercially available carbon fibers useful in this invention include Tenax® fibers available from Toho Tenax America, Inc. Commercially available liquid crystal polyester fibers useful in this invention include Vectran® HS fiber available from Swicofil AG Textile Services.

The honeycomb of this invention has 5 to 35 parts by weight thermoplastic material having a melting point of from 120° to 350° C. and a CTE of 180 ppm/° C. or less and in some preferred embodiments 100 ppm/° C. or less. Thermoplastic is meant to have its traditional polymer definition; these materials flow in the manner of a viscous liquid when heated and solidify when cooled and do so reversibly time and time again on subsequent heating and cooling steps. In some other preferred embodiments the melting point of the thermoplastic is from 180° to 300° C. In some other preferred embodiments the melting point of the thermoplastic is 220° to 250° C. While papers can be made with thermoplastic material having a melt point lower than 120° C., this paper can be susceptible to undesirable melt flow, sticking, and other problems after paper manufacture. For example, during honeycomb manufacture, after node line adhesive is applied to the paper, generally heat is applied to remove solvent from the adhesive. In another step, the sheets of paper are pressed together to adhere the sheets at the node lines. During either of these steps, if the paper has a low melt point thermoplastic material, that material can flow and undesirably adhere the paper sheets to manufacturing equipment and/or other sheets. Therefore, preferably the thermoplastic materials used in the papers can melt or flow during the formation and calendering of the paper, but do not appreciably melt or flow during the manufacture of honeycomb. Thermoplastic materials having a melt point above 350° C. are undesired because they require such high temperatures to soften that other components in the paper may begin to degrade during paper manufacture. In those embodiments where more than one type of thermoplastic material is present then at least 30% of the thermoplastic material should have melting point not above 350° C.

The CTE for a polymer, fiber or honeycomb is measured by a thermomechanical analyzer as specified in test method ASTM E831. Polymer samples can be tested directly. Fiber samples are often tested as unidirectional composites. The fibers are aligned in a single direction and then impregnated with a thermoset resin, such as an epoxy resin. The coefficient of thermal expansion is then measured in the axial direction. Honeycomb samples are tested in the Z direction. The test should be run on multiple cell walls, either by bridging a cell or by testing on the corner of a cell.

The thermoplastic material binds the high modulus fiber in the paper used in the honeycomb. The thermoplastic material can be in the form of flakes, particles, pulp, fibrids, floc or mixtures thereof. In some embodiments, these materials can form discrete film-like particles in the paper having a film thickness of about 0.1 to 5 micrometers and a minimum dimension perpendicular to that thickness of at least 30 micrometers. In one preferred embodiment, the maximum dimension of the particle perpendicular to the thickness is at most 1.5 mm.

The thermoplastic material useful in this invention includes thermoplastic material selected from the group consisting of polyester, polyolefin, polyamide, polyetherketone, polyetheretherketone, polyamide-imide, polyether-imide, polyphenylene sulfide, liquid crystal polyester, and mixtures thereof. In some preferred embodiments the thermoplastic material includes polypropylene or polyester polymers and/or copolymers.

The term “fibrids” as used herein, means a very finely-divided polymer product of small, filmy, essentially two-dimensional, particles known having a length and width on the order of 100 to 1000 micrometers and a thickness only on the order of 0.1 to 1 micrometer. Fibrids are typically made by streaming a polymer solution into a coagulating bath of liquid that is immiscible with the solvent of the solution. The stream of polymer solution is subjected to strenuous shearing forces and turbulence as the polymer is coagulated.

In some embodiments, the preferred thermoplastic polyester used in the paper in this invention is polyethylene terephthalate (PET) or polyethylene naphthalate (PEN) polymers. These polymers may include a variety of comonomers, including diethylene glycol, cyclohexanedimethanol, poly(ethylene glycol), glutaric acid, azelaic acid, sebacic acid, isophthalic acid, and the like. In addition to these comonomers, branching agents like trimesic acid, pyromellitic acid, trimethylolpropane and trimethyloloethane, and pentaerythritol may be used. The PET may be obtained by known polymerization techniques from either terephthalic acid or its lower alkyl esters (e.g. dimethyl terephthalate) and ethylene glycol or blends or mixtures of these. PEN may be obtained by known polymerization techniques from 2,6-naphthalene dicarboxylic acid and ethylene glycol.

In other embodiments, the preferred thermoplastic polyesters used are liquid crystalline polyesters. By a “liquid crystalline polyester” (LCP) herein is meant a polyester polymer that is anisotropic when tested using the TOT test or any reasonable variation thereof, as described in U.S. Pat. No. 4,118,372, which is hereby included by reference. One preferred form of LCP is “all aromatic”, that is all of the groups in the polymer main chain are aromatic (except for the linking groups such as ester groups), but side groups that are not aromatic may be present. LCP useful as thermoplastic material in this invention has melting point up to 350° C. A preferred LCP for this invention include corresponding grades of Zenite® available from E. I. du Pont de Nemours and Company, and Vectra® LCP available from Ticona Co.

Other materials, particularly those often found in or made for use in thermoplastic compositions may also be present in the thermoplastic material. These materials should preferably be chemically inert and reasonably thermally stable under the operating environment of the honeycomb. Such materials may include, for example, one or more of fillers, reinforcing agents, pigments and nucleating agents. Other polymers may also be present, thus forming polymer blends. In some embodiments, other polymers are present it is preferred that they are less than 25 weight percent of the composition. In another preferred embodiment, other polymers are not present in the thermoplastic material except for a small total amount (less than 5 weight percent) of polymers such as those that function as lubricants and processing aids.

One embodiment of this invention is an article comprising a honeycomb made from a paper comprising high modulus fiber and thermoplastic material wherein the thermoplastic material has a melting point of from 120° C. to 350° C. and a CTE of 180 ppm/° C. and preferably 100 ppm/° C. or less, and wherein the honeycomb has a coefficient of thermal expansion in the Z-dimension of 10 ppm/° C. or less, preferably 5 ppm/° C. or less, as measured by ASTM E831. When used in articles the honeycomb can function, if desired, as a structural component. In some preferred embodiments, the honeycomb is used at least in part in an aerodynamic structure. In some embodiments, the honeycomb has use as a structural component on satellites. Due to the lightweight structural properties of honeycomb, one preferred use is in aerodynamic structures wherein lighter weights allow savings in fuel or the power required to propel an object through the air.

Another embodiment of this invention is a panel comprising a honeycomb made from a paper comprising high modulus fiber and thermoplastic material wherein the thermoplastic material is at least partly present in the paper in the form of discrete film-like particles. One or more facesheets may be attached to the face of the honeycomb to form a panel. Facesheets provide integrity to the structure and help to realize the mechanical properties of the honeycomb core. Also, facesheets can seal the cells of the honeycomb to prevent material from the cells, or the facesheets can help retain material in the cells. FIG. 3 shows honeycomb 5 having a facesheet 6 attached to one face by use of an adhesive. A second facesheet 7 is attached to the opposing face of the honeycomb, and the honeycomb with the two opposing facesheets attached form a panel. Additional layers of material 8 can be attached to either side of the panel as desired. In some preferred embodiments face sheets applied to both sides of the honeycomb contain two layers of material. In some preferred embodiments, the facesheet comprises a woven fabric or a crossplied unidirectional fabric. In some embodiments crossplied unidirectional fabric is a 0/90 crossply. If desired, the facesheet can have a decorative surface, such as embossing or other treatment to form an outer surface that is pleasing to the eye. Fabrics containing glass fiber and/or carbon fiber are useful as facesheet material.

In some embodiments the honeycomb can be made by methods such as those described in U.S. Pat. Nos. 5,137,768; 5,789,059; 6,544,622; 3,519,510; and 5,514,444. These methods for making honeycomb generally require the application or printing of a number of lines of adhesive (node lines) at a certain width and pitch on one surface of the high modulus paper, followed by drying of the adhesive. Typically the adhesive resin is selected from epoxy resins, phenolic resins, acrylic resins, polyimide resins and other resins, however, it is preferred that a thermoset resin be used.

After application of node lines, the high modulus paper is cut at a predetermined interval to form a plurality of sheets. The cut sheets are piled one on top of the other such that each of the sheets is shifted to the other by half a pitch or a half the interval of the applied adhesive. The piled high modulus fiber-containing paper sheets are then bonded to each other along the node lines by the application of pressure and heat. The bonded sheets are then pulled apart or expanded in directions perpendicular to the plane of the sheets to form a honeycomb having cells. Consequently, the formed honeycomb cells are composed of a planar assembly of hollow, columnar cells separated by cell walls made of paper sheets that were bonded to each other along a number of lines and which were expanded.

In some embodiments, the honeycomb is then typically impregnated with a structural resin after it is expanded. Typically this is accomplished by dipping the expanded honeycomb into a bath of thermoset resin, however, other resins or means such as sprays could be employed to coat and fully impregnate and/or saturate the expanded honeycomb. After the honeycomb is fully impregnated with resin, the resin is then cured by heating the saturated honeycomb to crosslink the resin. Generally this temperature is in the range of 150° C. to 180° C. for many thermoset resins.

The honeycomb before or after resin impregnation and curing, may be cut into slices. In this way, multiple thin sections or slices of honeycomb can be obtained from a large block of honeycomb. The honeycomb is generally sliced perpendicular to the plane of the cell edges so that the cellular nature of the honeycomb is preserved.

The honeycomb can further comprise inorganic particles, and depending on the particle shape, the particular paper composition, and/or other reasons, these particles can be incorporated into the paper during papermaking (for example, mica flakes, vermiculite, and the like) or into they may be incorporated into the matrix or structural resin (for example, silica powder, metal oxides, and the like.)

### TEST METHODS

The coefficient of thermal expansion for a polymer and the honeycomb is measured by ASTM E831. The coefficient of thermal expansion for a fiber can be measured directly or from composite structure following ASTM E381.

Melting points are measured per test method ASTM D3418. Melting points are taken as the maximum of the melting endotherm, and are measured on the second heat at a heating rate of 10° C./min. If more than one melting point is present the melting point of the polymer is taken as the highest of the melting points.

Fiber modulus, strength, and elongation are measured using ASTM D885. Paper density is calculated using the paper thickness as measured by ASTM D374 and the basis weight as measured by ASTM D646. Fiber denier is measured using ASTM D1907.

### EXAMPLES

This is an example of a honeycomb having a low coefficient of thermal expansion. Strand cut pellets of LCP is refined on a 30.5 cm diameter Sprout-Waldron type C-2976-A single rotating disc refiner in one pass with the gap between plates of about 25 micrometers, a feed speed of about 60 g/min. and continuous addition of water in quantity of about 4 kg of water per 1 kg of the pellets. The LCP has the composition of Example 5 of U.S. Pat. No. 5,110,896, derived from hydroquinone/4,4′-biphenol/terephthalic acid/2,6-naphthalenedicarboxylic acid/4-hydroxybenzoic acid in molar ratio 50/50/70/30/350. No glass transition can be observed for this LCP, and its melting point is 342° C. The coefficient of thermal expansion in the plane of the compressed LCP is 35 ppm/° C. The resulting LCP pulp is additionally refined in a Bantam® Micropulverizer, Model CF, to pass through a 30 mesh screen. An aramid/thermoplastic paper containing 70 parts by weight of para-aramid floc and 30 parts by weight of the LCP pulp; is formed on conventional paper forming equipment. The para-aramid floc is poly (para-phenylene terephthalamide) fiber sold by E. I. du Pont de Nemours and Company of Wilmington, Del. (DuPont) under the trademark KEVLAR® 49 and has a nominal filament linear density of 1.5 denier per filament (1.7 dtex per filament) and a nominal cut length of 6.7 mm. This fiber has a tensile modulus of 930 grams per denier (850 grams per dtex), a tensile strength of 24 grams per denier (22 grams per dtex), an elongation of 2.5 percent, and an axial coefficient of thermal expansion of −4 ppm/C. The paper is calendered under 1200 N/cm of linear pressure at 335° C. This produces an aramid/thermoplastic paper with a density of 0.75 g/cm³.

A honeycomb is then formed from the calendered paper. Node lines of adhesive are applied to the paper surface at a width of 2 mm and a pitch of 5 mm. The adhesive is a 50% solids solution comprising 70 parts by weight of an epoxy resin identified as Epon 826 sold by Shell Chemical Co.; 30 parts by weight of an elastomer-modified epoxy resin identified as Heloxy WC 8006 sold by Wilmington Chemical Corp, Wilmington, Del., USA; 54 parts by weight of a bisphenol A—formaldehyde resin curing agent identified as UCAR BRWE 5400 sold by Union Carbide Corp.; 0.6 parts by weight of 2-methylimidazole as a curing catalyst, in a glycol ether solvent identified as Dowanol PM sold by The Dow Chemical Company; 7 parts by weight of a polyether resin identified as Eponol 55-B-40 sold by Miller-Stephenson Chemical Co.; and 1.5 parts by weight of fumed silica identified as Cab-O-Sil sold by Cabot Corp. The adhesive is partially cured on the paper in an oven at 130° C. for 6.5 minutes.

The sheet with the adhesive node lines is cut into 500 mm lengths. 40 sheets are stacked one on top of the other, such that each of the sheets is shifted to the other by half a pitch or a half the interval of the applied adhesive node lines. The shift occurs alternately to one side or the other, so that the final stack is uniformly vertical.

The stacked sheets are then hot-pressed at the softening point of the adhesive, causing the adhesive node lines to melt; once the heat is removed the adhesive then hardens to bond the sheets with each other. For the node line adhesive above, the hot press operates at 140° C. for 30 minutes and then 177° C. for 40 minutes at 3.5 kg per square cm pressure.

The bonded aramid sheets are then expanded in the direction counter to the stacking direction to form cells having a equilateral cross section. Each of the sheets are extended between each other such that the sheets are folded along the edges of the bonded node lines and the portions not bonded are extended in the direction of the tensile force to separate the sheets from each other. A frame is used to expand and hold the honeycomb in the expanded shape.

The expanded honeycomb is then placed in a bath containing PLYOPHEN 23900 solvent-based phenolic resin from the Durez Corporation. The phenolic resin is used in a liquid form wherein the resin is dissolved or dispersed in 2-Propanol, water and Ethanol. The resin adheres to and covers the interior surface of the cell walls and can also fill in and penetrate into the pores of the paper.

After impregnated with resin, the honeycomb is taken out from the bath and is dried in a drying furnace by hot air at 140° C. for 30 minutes and at 177° C. for 40 minutes to remove the solvent and harden the phenolic resin. The impregnation step in the resin bath and the drying step in the drying furnace are repeated for 2 times to reach total content of thermoset resin in the honeycomb of about 33 weight percent. The frame holding the honeycomb is then removed. A sample of honeycomb having a size of 6 mm×25 mm, when tested according to ASTM E831 using a Q-400 Thermomechanical Analyzer from TA Instruments (New Castle, Del. (USA)), will show a CTE of about 3 ppm/C.

What is claimed is:

1. A honeycomb having cell walls provided with a structural or matrix resin, the planes of the cell walls being parallel to the Z-dimension of the honeycomb, the honeycomb cell walls comprising:
a) 5 to 35 parts by weight thermoplastic material having a melting point of from 120° C. to 350° C. and a coefficient of thermal expansion of less than 180 ppm/° C.; and
b) 65 to 95 parts by weight of a high modulus fiber having a modulus of 525 grams per denier (480 grams per dtex) or greater, and having an axial coefficient of thermal expansion of 2 ppm/° C. or less, based on the total amount of thermoplastic and high modulus fiber in the honeycomb cell walls;
wherein the honeycomb has a coefficient of thermal expansion in the Z-dimension of 10 ppm/° C. or less.

2. The honeycomb of claim 1 wherein the thermoplastic material is present in amount of 5 to 20 parts by weight.

3. The honeycomb of claim 1 wherein the high modulus fiber is present in an amount of from about 80 to 95 parts by weight.

4. The honeycomb of claim 1 wherein the thermoplastic material has a coefficient of thermal expansion of 100 ppm/° C. or less.

5. The honeycomb of claim 1 wherein the high modulus fiber has an axial coefficient of thermal expansion of (−1) ppm/° C. or less.

6. The honeycomb of claim 1 wherein the honeycomb has a coefficient of thermal expansion in the Z-dimension of 5 ppm/° C. or less.

7. The honeycomb of claim 1 wherein the thermoplastic is selected from the group consisting of polyester, polyolefin, polyamide, polyetherketone, polyetheretherketone, polyamide-imide, polyether-imide, polyphenylene sulfide, liquid crystal polyester, and mixtures thereof.

8. The honeycomb of claim 1 wherein the thermoplastic material includes an inorganic additive.

9. The honeycomb of claim 1 wherein at least 50 percent by weight of the high modulus fiber is in the form of floc.

10. The honeycomb of claim 9 wherein the floc has a cut length of from 2 mm to 25 mm.

11. The honeycomb of claim 1 wherein the high modulus fiber comprises poly (paraphenylene terephthalamide) fiber.

12. The honeycomb of claim 1 wherein the high modulus fiber is selected from the group of para-aramid, polybenzazole, polypyridazole polymer, liquid crystal polyesters, carbon, or mixtures thereof

13. The honeycomb of claim 1 wherein the structural or matrix resin is a thermoset resin.

14. The honeycomb of claim 1 further comprising inorganic particles.

15. An article comprising the honeycomb of claim 1.

16. An aerodynamic structure comprising the honeycomb of claim 1.

17. A panel comprising the honeycomb of claim 1.

18. The panel of claim 17 further comprising a facesheet attached to a face of the honeycomb.
